(19) United States
(12) Patent Application Publication
(10) Pub. No.: US 2007/0062643 A1
(43) Pub. Date: Mar. 22, 2007

(54) Method of separating adhesive-bonded body

(76) Inventors: Yoshihiko Watanabe, Shizuoka (JP); Takashi Uematsu, Shizuoka (JP); Yuichiro Yamamura, Shiga (JP); Mikotoshi Suematsu, Shiga (JP); Shinishi Yamaguchi, Shiga (JP); Masanori Matsuda, Shiga (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/571,552

(22) PCT Filed: Sep. 9, 2004
(86) PCT No.: PCT/JP04/13162

§ 371 Date: Oct. 31, 2006

(30) Foreign Application Priority Data
Sep. 12, 2003 (JP) 2003-321732

(51) Int. Cl. B29C 63/00

(52) U.S. Cl. 156/344

(57) ABSTRACT

A method of separating an adhesive-bonded body is provided, by which a pair of pieces bonded together by using an adhesive can be easily securely separated from each other, wherein the adhesive has excellent adhesive force without being influenced by environmental temperature, excellent storage stability and wide scope of selection of the piece to be bonded. An adhesive-bonded body 1 includes a pair of pieces 2 bonded together and an adhesive layer 4. The adhesive layer 4 bonds the pair of pieces 2 to each other. Ultrasonic vibration is applied to the adhesive-bonded body 1 which is put between a tool horn 6 and an anvil 7 of an ultrasonic vibration applying device 3. The ultrasonic vibration is generated by applying a voltage to a piezoelectric vibrator 5 and vibrates the tool horn 6. The tool horn 6 vibrates ultrasonically together with one piece 2. The pair of the pieces 2 bonded together shifts relatively each other due to the ultrasonic vibration. The adhesive layer 4 is heated due to the ultrasonic vibration, so that the strength of the adhesive layer 4 is decreased. The pair of pieces 2 bonded together of the adhesive-bonded body 1, which includes the adhesive layer 4 having the decreased strength due to the ultrasonic vibration, is separated into the respective separated pieces.

### TECHNICAL FIELD

The present invention relates to a method of separating an adhesive-bonded body, by which the body including a pair of pieces bonded to each other by an adhesive layer is separated into the respective separated pieces, for example, for the purpose of recycling.

### BACKGROUND ART

An inherent function of an adhesive is “to bond a matter to another matter”. The “adhesion” by using an adhesive has various advantages (such as uniform dispersion of stress, making bonding of different kinds of material possible, and light weight). On the other hand, the “adhesion” by using an adhesive has a drawback that it is difficult to disassemble an adhesive layer consisting of the adhesive by which a pair of pieces is bonded together.

The method of bonding a pair of pieces together by using an adhesive has been utilized in many technical fields such as building materials, parts of motor vehicles, business things, household appliances, electronics products. Recently, recycling of an adhesive-bonded body has been required from the viewpoints of environment problems, natural resources depletion problems and so on.

When a pair of pieces bonded together by using an adhesive is recycled, of course, the pair of the bonded pieces must be separated into the respective separated pieces. So far, methods of separating a body, including a pair of pieces bonded together by an adhesive, into the respective separated pieces have been as follows.

When an adhesive having thermoplastic resin as its main component is used as the adhesive which composes the adhesive layer, first, the adhesive layer is softened by heating to reduce the mechanical strength of the adhesive layer. Then, after bonded pieces are separated from each other, the separated pieces are recovered (for example, see Patent Publications 1 and 2).

In Patent Publication 1, there is described a method of separating a pair of bonded pieces which is bonded together by using an emulsion-type adhesive including vinyl acetate resin as its main component, metallic soap and wax. In Patent Publication 1, there is described a method, in which after the bonded body is heated up to a softening point of the emulsion-type adhesive, a pair of the bonded pieces is separated into the respective separated pieces. In Patent Publication 1, there is described a method, in which a pressing plate including a heater therein is used as a mean for heating the emulsion-type adhesive up to a softening point thereof and the heated pressing plate is made come in contact with the bonded piece so as to heat the emulsion-type adhesive.

In Patent Publication 2, there is described a method of separating a pair of bonded metal plates, in which an adhesive. including thermoplastic resin is used and the adhesive is applied on the metal plate to form a coating which bonds the pair of the metal plates together. In Patent Publication 2, there is described a method of separating a pair of bonded metal plates, in which after the bonded metal plate is heated to a temperature higher than a melting point of the thermoplastic resin, the pair of the bonded metal plates is separated from each other. As a method of the heating, there is described a heating for a short period of time by utilizing the electrical resistance of the metal plate such as high frequency induction heating (i.e. induction heating) or direct electric resistance heating.

Further, proposed is a method of separating a pair of pieces bonded together, in which ultrasonic vibration generated by applying a voltage to a piezoelectric vibrator is transmitted to a cutter blade and the ultrasonically vibrating cutter blade is made come in contact with an adhesive layer consisting of an adhesive cured between the pair of the pieces bonded together so as to separate the pair of the pieces bonded together into the respective separated pieces (see Patent Publications 3). In Patent Publication 3, there is described a method, in which the cutter blade described above is made directly come in contact with the adhesive layer and the adhesive layer is softened or melted with frictional heat generated by pressing, so that the adhesive layer is cut by the cutter blade so as to separate the pair of the pieces bonded together into the respective separated pieces and recover them.

Patent Publication 1: Japanese Patent Application Laid-Open No. H8-325530

Patent Publication 2: Japanese Patent Application Laid-Open No. 2002-240190

Patent Publication 3: Japanese Patent Application Laid-Open No. H10-202657

### DISCLOSURE OF THE INVENTION

### Problems that the Invention is to Solve

However, as for the adhesive including thermoplastic resin as its main component, since the adhesive has a poor heat resisting property due to a characteristic thereof and the basic adhesive strength thereof is low, therefore the scope of application of the adhesive is limited. Further, with the methods disclosed in Patent Publications 1 and 2, it is impossible to separate pieces bonded together by using an adhesive consisting of thermosetting resin. Further, the methods disclosed in Patent Publications 1 and 2 are hardly applied to a piece to be bonded having a low thermal conductivity such as foamed inorganic material because a step for heating an adhesive layer together with bonded pieces is indispensable. That is, if it is not possible to heat only an adhesive exclusively, there is a problem that the methods disclosed in Patent Publications 1 and 2 cannot be applied to a piece to be bonded which is deteriorated by heat (for example, a piece, mechanical strength of which being decreased by heat).

Further, as for the method disclosed in Patent Publications 3 in which an ultrasonically vibrating cutter blade is used, if each of the pair of the pieces is hard (i.e. hardly elastically deformed), it becomes difficult to keep the cutter blade coming in contact with an adhesive layer as the cutting of the adhesive layer is advancing. Thus, with the method disclosed in Patent Publications 3, only the adhesive layer within a range thereof, with which the cutter blade can come in contact, can be cut. Further, if the piece to be bonded has a complicated shape or a large size, there is a problem that a physical cutting requires a great deal of man-hour and time.

It is therefore an objective of the present invention to solve the above problems and to provide a method of separating an adhesive-bonded body, by which a pair of pieces bonded together by using an adhesive can be easily securely separated from each other, wherein the adhesive has excellent adhesive force without being influenced by environmental temperature, excellent storage stability and wide scope of selection of the piece to be bonded.

### Means of Solving the Problems

In order to attain the above objective, a method of separating an adhesive-bonded body according to the present invention as defined in claim 1 is a method of separating an adhesive-bonded body including a pair of pieces bonded together by an adhesive layer into the respective separated pieces including the step of:

affecting the adhesive layer with ultrasonic vibration through at least one piece of the pair of the pieces bonded together, thereby separating the pair of the pieces bonded together into the respective separated pieces.

A method of separating an adhesive-bonded body according to the present invention as defined in claim 2 is, in the method of separating an adhesive-bonded body as defined in claim 1, characterized in that the ultrasonic vibration is generated by applying a voltage to a piezoelectric vibrator so as to vibrate the piezoelectric vibrator and the ultrasonic vibration is transmitted to the adhesive layer through a tool horn which comes in contact with at least one piece of the pair of the pieces bonded together.

A method of separating an adhesive-bonded body according to the present invention as defined in claim 3 is, in the method of separating an adhesive-bonded body as defined in claim 1 or 2, characterized in that the ultrasonic vibration is a vibration along a direction in which the pair of the pieces bonded together overlaps each other.

A method of separating an adhesive-bonded body according to the present invention as defined in claim 4 is, in the method of separating an adhesive-bonded body as defined in claim 1 or 2, characterized in that the ultrasonic vibration is a vibration along a direction crossing at right angles a direction in which the pair of the pieces bonded together overlaps each other.

A method of separating an adhesive-bonded body according to the present invention as defined in claim 5 is, in the method of separating an adhesive-bonded body as claimed in any one of claims 1-4, characterized in that the adhesive layer consists of a reactive adhesive.

As a method of separating an adhesive-bonded body, that is, a method of stripping off an adhesive layer, the inventors sought a method by which pieces bonded together can be prevented from being seriously damaged and an adhesive layer that cannot be seen being hidden by the pieces bonded together can be stripped off in a short period of time. The breaking of the adhesive layer consisting of an adhesive might be easy provided that it is possible to simply heat the adhesive-bonded body together with the adhesive layer. However, if the adhesive-bonded body is simply heated together with the adhesive layer, the pieces bonded together are broken as well as the adhesive layer. Therefore, the energy must be transmitted to the adhesive layer in such a manner that the pieces bonded together are not broken.

The inventors directed their attention to “vibration” that can transmit (give) high energy to an interface (hereinafter, adhesive interface) between the bonded piece and the adhesive layer or to the adhesive layer in a short period of time. Normally, the “vibration” means macroscopic vibration or microscopic vibration. The former relates to shaking with a hand or using a vibrator, while the latter relates to ultrasonic vibration. An essence of the technique in the present invention relates to how the energy of ultrasonic vibration is utilized in order to apply the energy intensively to a portion where the stripping of the adhesive layer is required. The inventors found out the following matters.

That is, the present invention is a method of separating an adhesive-bonded body including a pair of pieces bonded together by an adhesive layer into the respective separated pieces including the step of: affecting the adhesive layer with ultrasonic vibration through one piece or both pieces of the pair of the pieces bonded together, so that the pair of the pieces bonded together can be easily separated from each other into the respective separated pieces.

With the method of separating an adhesive-bonded body according to the present invention as defined in claim 1, the ultrasonic vibration can be effectively transmitted to the adhesive layer through the bonded piece, therefore the bonded piece can be prevented from being seriously damaged and the pair of the pieces bonded together can be separated from each other effectively in a short period of time. Further, a thermosetting adhesive can be used in the present invention, therefore a method according to the present invention is practical and applied widely.

With the method of separating an adhesive-bonded body according to the present invention as defined in claim 2, the ultrasonic vibration is applied through a tool horn. Therefore, the ultrasonic vibration can be securely applied to the adhesive layer situated between the pair of the pieces bonded together.

With the method of separating an adhesive-bonded body according to the present invention as defined in claim 3, the ultrasonic vibration is generated vibrating along a direction in which the pair of the pieces bonded together overlaps each other. Therefore, the mechanical strength of the adhesive layer situated between the pair of the pieces bonded together can be securely decreased. Further, since the ultrasonic vibration is generated vibrating along a direction in which the pair of the pieces bonded together overlaps each other, therefore the mechanical strength of the adhesive layer can be securely decreased, particularly when a pair of the pieces made of synthetic resin are separated from each other.

With the method of separating an adhesive-bonded body according to the present invention as defined in claim 4, the ultrasonic vibration is generated vibrating along a direction crossing at right angles a direction in which the pair of the pieces bonded together overlaps each other. Therefore, the mechanical strength of the adhesive layer situated between the pair of the pieces bonded together can be securely decreased. Further, since the ultrasonic vibration is generated vibrating along a direction crossing at right angles a direction in which the pair of the pieces bonded together overlaps each other, therefore the mechanical strength of the adhesive layer can be securely decreased, particularly when a pair of the pieces made of metal are separated from each other.

With the method of separating an adhesive-bonded body according to the present invention as defined in claim 5, the adhesive layer consisting of a reactive adhesive is used. Therefore, a pair of pieces bonded together of the adhesive-bonded body including an adhesive layer consisting of a reactive adhesive such as an adhesive of two component-type, thermosetting-type, moisture-setting-type or photoreaction-type can be separated into the respective separated pieces. Further, since the adhesive layer consisting of a reactive adhesive is used, the scope of the application is wider than that in a case when an adhesive consisting of thermoplastic resin is used.

The ultrasonic vibration in the present invention means vibration obtained by transforming electric energy into mechanical vibration. For example, ultrasonic vibration is generated by applying a voltage to a piezoelectric vibrator so as to vibrate the piezoelectric vibrator. Then, the ultrasonic vibration is transmitted to a tool horn which presses the adhesive-bonded body in a direction in which the pair of the pieces bonded together approaches to each other and then, through the tool horn, the ultrasonic vibration is transmitted to the adhesive layer through one or both of the bonded pieces.

The ultrasonic vibration transmitted to the adhesive layer through the bonded piece excites energy within the adhesive layer and breaks only the adhesive layer. That is, the energy can be concentrated selectively within the adhesive layer. Therefore, the bonded piece can be prevented from being seriously damaged and the pair of the bonded pieces can be separated from each other. In order to promote the transmission of the ultrasonic vibration, important factors are a vibration frequency, vibration time, vibration amplitude, longitudinal vibration and lateral vibration. Therefore, these factors are preferably decided depending on a practical condition since these factors are greatly affected by, for example, size, thickness and material of the bonded piece and the adhesive layer. The longitudinal vibration means that the piezoelectric vibrator or the tool horn vibrates along a direction in which the bonded piece that comes in contact with the tool horn overlaps with the opposite bonded piece. The lateral vibration means that the piezoelectric vibrator or the tool horn vibrates along a direction crossing at right angles a direction in which the bonded piece that comes in contact with the tool horn overlaps with the opposite bonded piece.

The vibration time period of the ultrasonic vibration in the present invention is preferably 1 second, less than 1 second or a few seconds. This time period in the present invention is shorter than that of a conventional case in which the adhesive layer is simply heated together with the bonded pieces by using a means such as an oven or a conventional case in which the adhesive layer is cut physically by using a cutter blade vibrating ultrasonically. That is, the method of the present invention is effective compared to the conventional methods as described above. Further, in the present invention, the bonded piece can be prevented from being seriously damaged due to deterioration by heat (i.e. deterioration in the mechanical strength due to the heating), which might occur in the conventional case in which the adhesive layer is simply heated together with the bonded pieces.

In the method of the present invention, when the longitudinal vibration of the ultrasonic vibration is applied to the bonded piece, a decreasing ratio of strength of the adhesive layer to keep the pair of the bonded pieces being bonded is larger than that when the lateral vibration of the ultrasonic vibration is applied to the bonded piece under the same condition. That is, the longitudinal vibration can reduce the mechanical strength of the adhesive layer situated between the pair of the pieces bonded together more than the lateral vibration can.

In the present invention, an adhesive that composes the adhesive layer is not limited to particular adhesives. Generally, adhesives are classified into non-reactive adhesives and reactive adhesives. The non-reactive adhesive means a type of adhesive in which bonding due to chemical reaction does not take place within the adhesive layer, on the other hand, the reactive adhesive means a type of adhesive in which chemical bonding takes place after chemical reaction not depending on whether the chemical bonding is two-dimensional or three-dimensional.

The non-reactive adhesive is, for example, a vinyl acetate resin-based (including emulsion-type and solvent-type), polyvinyl alcohol-based, polyvinyl acetal-based (including butyral and formal), vinyl chloride-based, acrylic resin-based (including emulsion-type and cyanoacrylate-type), polyamide-based, polyethylene-based, EVA (ethylene-vinyl acetate copolymer)-based, chloroprene rubber-based (including solvent-type and latex-type), nitrile rubber-based (including solvent-type, latex-type and film-type), styrene-butadiene rubber-based (including solvent-type and latex-type), SIS rubber-based, SBS rubber-based, SEBS rubber-based, and SEPS rubber-based adhesive.

The reactive adhesive is, for example; a two component setting-type adhesive such as a urea resin-based, melamine resin-based, phenolic resin-based, resorcinol-based, epoxy resin-based, polyurethane-based and polysulfide-based (including epoxy mix-type and sealant-type) adhesive; thermosetting-type adhesive such as polyimide-based and polybenzimidazole-based adhesive; and moisture-setting-type adhesive such as polyurethane-based, silicone rubber-based and modified silicone-based adhesive. Also, the reactive adhesive includes an adhesive which causes crosslinking reaction by ultraviolet light or electron beam and an adhesive which sets only on a anaerobic condition.

Two or more kinds of adhesive described above may be used. Even as for the adhesive classified as the non-reactive adhesive, there may be a reaction in a special occasion. In such an occasion, the non-reactive adhesive is handled as a reactive-type adhesive.

In the method of the present invention, the reactive adhesive is preferably used. In the conventional method, an effective separation of the bonded body can be attained only by using a thermoplastic adhesive. However, a thermoplastic adhesive has a drawback of poor bonding strength and poor heat resistance due to its own property. According to the method of the present invention, the separation is possible even by using a reactive adhesive. The reactive adhesive includes, for example, an epoxy-based adhesive which sets by chemical reaction between two components, and polyurethane-based, silicone rubber-based and modified silicone-based adhesive which require moisture besides heat. Also, the reactive adhesive includes an adhesive which causes crosslinking reaction by ultraviolet light or electron beam and an adhesive which sets only on a anaerobic condition. Particularly, combination of modified silicone-based and epoxy-based adhesives is preferable since designing of viscoelasticity thereof is freely carried out according to a need.

A reason why the reactive adhesive is preferably used in the present invention is that on account of the nature of ultrasonic vibration, when the separation method of the present invention is applied to the reactive adhesive, the heat resistance and the strength after bonding with setting is improved, while upon separation of the bonded pieces, the separation can be carried out simply without damage of the bonded pieces.

Further, thermally expansive hollow particles can be mixed into the adhesive in the present invention. In this case, it is possible to securely separate the bonded pieces having a low thermal conductivity such as foamed inorganic material and further, the bonded pieces that tend to be deteriorated by heat (i.e. the mechanical strength thereof being deteriorated by heating) can be securely separated from each other without being deteriorated by heat.

In the present invention, the piece (to be bonded to the opposite piece) is, for example, an article consisting of metal such as aluminum, stainless steel, copper, iron, titanium, silicon; article consisting of inorganic substance (inorganic compound) such as earthenware (pottery) and slate; article consisting of organic substance (organic compound) such as polycarbonate, acrylic resin, ABS (Acrylonitrile-butadiene-styrene) resin, silicone resin, polyester, polypropylene, polyethylene, polyvinyl chloride and polyamide; and article consisting of ligneous substance such as wood, MDF and particle board. The piece (to be bonded to the opposite piece) composes various parts (mainly structural parts) such as building materials, parts of motor vehicles, business things, household appliances, electronics products.

### Effects of the Invention

As described above, in the present invention as defined in claim 1, an ultrasonic vibration is transmitted to the adhesive layer to cause the adhesive layer to be broken or the strength of the adhesive layer to be decreased so as to enable the separation of the pieces bonded together. Differently from the breaking of the adhesive layer by normal heating, energy can be intensively applied to the adhesive layer instead of simultaneous heating of the pieces bonded together. Therefore, a pair of the pieces bonded together by using an adhesive can be easily securely separated from each other by using an adhesive (i.e. thermosetting adhesive or reactive adhesive), which has excellent adhesive force without being influenced by environmental temperature, excellent storage stability and wide scope of selection of the piece to be bonded.

Further, since energy can be intensively applied to the adhesive layer instead of simultaneous heating of the pieces bonded together, therefore the bonded piece can be prevented from being seriously damaged and the pair of the pieces bonded together can be separated from each other effectively in a short period of time. Further, a thermosetting adhesive can be used in the present invention, therefore a method according to the present invention is practical and applied widely.

Further, since the pieces bonded together are not simultaneously heated, therefore freedom of selecting material of the piece is large.

According to the present invention as defined in claim 2, since the ultrasonic vibration can be securely applied to the adhesive layer situated between the pair of the pieces bonded together, the pair of the bonded pieces can be securely separated into the respective separated pieces.

According to the present invention as defined in claim 3, since the mechanical strength of the adhesive layer situated between the pair of the pieces bonded together can be securely decreased, therefore, particularly, a pair of the pieces made of synthetic resin can be securely separated from each other.

According to the present invention as defined in claim 4, since the mechanical strength of the adhesive layer situated between the pair of the pieces bonded together can be securely decreased, therefore, particularly, a pair of the pieces made of metal can be securely separated from each other.

The present invention as defined in claim 5 can be applied to an adhesive-bonded body including an adhesive layer consisting of a thermosetting adhesive having excellent thermal adhesion resistance and excellent adhesive force. Further, the adhesive layer and the bonded piece can be separated from each other in a short period of time without occurrence of dust or noise, thereby contributing to development of recycling business or promotion of recycling.

### BRIEF DESCRIPTION OF THE DRAWINGS

FIG. 1 is a perspective view of an adhesive-bonded body including a pair of pieces bonded together which is separated from each other by a method of separating an adhesive-bonded body according to the present invention.

FIG. 2 is a sectional view taken along II-II line in FIG. 1.

FIG. 3 is a view illustrating a state when the adhesive-bonded body shown in FIG. 2 is put between a tool horn and an anvil of an ultrasonic vibration applying device.

FIG. 4 is a view illustrating a state when a pair of pieces bonded together of an adhesive-bonded body shown in FIG. 3 is being separated from each other.

FIG. 5 is a view illustrating another example of the ultrasonic vibration applying device shown in FIG. 3.

FIG. 6 is a view illustrating a further example of the ultrasonic vibration applying device shown in FIG. 3.

### ABBREVIATION NUMERALS

1: adhesive-bonded body

2: bonded piece

4: adhesive layer

5: piezoelectric vibrator

6: tool horn

X: a direction crossing at right angles a direction in which a pair of pieces bonded together overlaps each other

Z: a direction in which a pair of pieces bonded together overlaps each other

### BEST MODE FOR CARRING OUT THE INVENTION

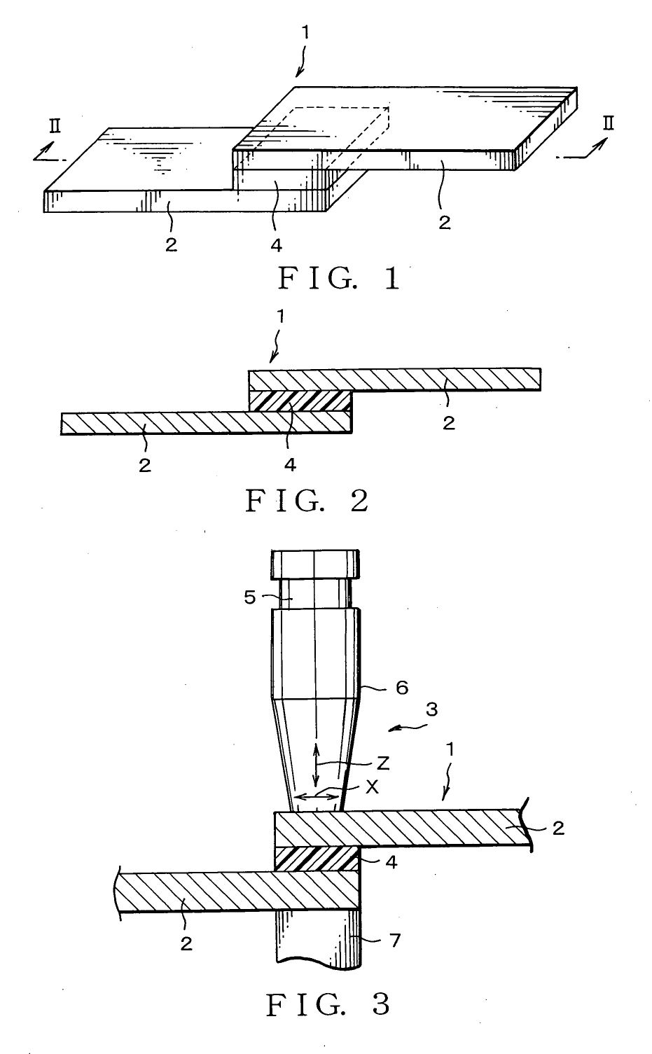

In the following, a preferred embodiment of the present invention is explained with reference to FIGS. 1-4. A method of separating an adhesive-bonded body according to the first preferred embodiment of the present invention is a method of separating a pair of bonded pieces 2 from each other in an adhesive-bonded body 1 shown in FIGS. 1 and 2 by using an ultrasonic vibration applying device 3 (or ultrasonic welding device, ultrasonic joining device) shown in FIG. 3.

As shown in FIGS. 1 and 2, the adhesive-bonded body 1 includes a pair of the pieces 2 and an adhesive layer 4. In the example, each piece 2 is formed in a flat plate-shape. The piece 2 is a part (mainly constitutional part) of a product as described above. The piece 2 consists of a substance as described above.

The adhesive layer 4 is formed between the pair of the pieces 2 in order to bond these piece 2 together. The adhesive layer 4 is obtained by setting a known adhesive having a liquid, sol or gel shape between the pair of the pieces 2. The adhesive layer 4 bonds the pair of the pieces 2 together. The adhesive layer 4 consists of a known adhesive.

As the adhesive for constructing the adhesive layer 4, an adhesive as described above can be used.

Further, as the adhesive for constructing the adhesive layer 4, an adhesive as described above, into which thermally expansive hollow particles are mixed, can be used. In this case, it is possible to securely separate the bonded pieces having a low thermal conductivity such as foamed inorganic material and further, the bonded pieces that tend to be deteriorated by heat (i.e. the mechanical strength thereof being deteriorated by heating) can be securely separated from each other without being deteriorated by heat.

As shown in FIG. 3, an ultrasonic vibration applying device 3 includes a piezoelectric vibrator 5 as a driving source, tool horn 6, anvil 7 and pressing machine (not shown in the figure). The piezoelectric vibrator 5 vibrates ultrasonically, for example, of a frequency range from 10 kHz to 80 kHz by being supplied with electric power from an electric source (not shown in the figure). At that time, the piezoelectric vibrator 5 vibrates ultrasonically along an arrow Z or arrow X in FIG. 3.

The arrow Z has a direction, in which the pair of the pieces 2 bonded together overlaps each other, wherein the pair of the pieces 2 bonded together is put between the tool horn 6 and the anvil 7. The arrow X has a direction crossing at right angles a direction of the arrow Z. That is, the direction of the arrow X is parallel to a length direction of the piece 2. In the specification, longitudinal vibration means that the piezoelectric vibrator 5 vibrates ultrasonically along the arrow Z, while lateral vibration means that the piezoelectric vibrator 5 vibrates ultrasonically along the arrow X.

The ultrasonic vibration is vibration, which is generated by applying a voltage to the piezoelectric vibrator 5 so as to vibrate the piezoelectric vibrator 5 thereby converting electric energy to mechanical vibration.

The tool horn 6 is attached to the piezoelectric vibrator 5. Therefore, due to the ultrasonic vibration of the piezoelectric vibrator 5, the tool horn 6 vibrates along the arrow Z or X. The anvil 7 faces the tool horn 6 having a distance therebetween. The adhesive-bonded body 1 to be separated is put between the tool horn 6 and the anvil 7. The pressing machine presses the tool horn 6 and anvil 7 in a direction, in which the tool horn 6 and anvil 7 approach to each other. The pressing machine can change a load value (pressure value) for pressing the tool horn 6 and anvil 7.

The ultrasonic vibration applying device 3 puts the adhesive-bonded body 1 to be separated between the tool horn 6 and the anvil 7. At that time, the adhesive-bonded body 1 is put between the tool horn 6 and the anvil 7 in such a manner that a direction in which the tool horn 6 and the anvil 7 face each other is parallel to a direction in which the pair of the bonded pieces 2 overlaps with each other. The tool horn 6 comes in contact with one piece 2 of the pair of the bonded pieces 2.

Then, on a condition that the pressing machine presses the tool horn 6 and anvil 7 in a direction in which the tool horn 6 and anvil 7 approach each other, the ultrasonic vibration applying device 3 applies a voltage to the piezoelectric vibrator 5 so as to vibrate the piezoelectric vibrator 5, so that the ultrasonic vibration is transmitted to the tool horn 6. Then, the ultrasonic vibration applying device 3 applies ultrasonic vibration, for example, of a frequency range from 10 kHz to 80 kHz to the adhesive-bonded body 1, which is put between the tool horn 6 and the anvil 7.

Thus, the ultrasonic vibration applying device 3 applies a voltage to the piezoelectric vibrator 5 to vibrate the piezoelectric vibrator 5, thereby generating the ultrasonic vibration. The ultrasonic vibration applying device 3 transmits the ultrasonic vibration to one piece 2, which comes in contact with the tool horn 6, through the tool horn 6, which comes in contact with the one piece 2 of the pair of the bonded pieces 2, and allows the ultrasonic vibration to affect the adhesive layer 4 through the one piece 2.

As shown in FIG. 3, when the pair of the bonded pieces 2 in the adhesive-bonded body 1 is being separated from each other by using the ultrasonic vibration applying device 3, the adhesive-bonded body 1 is put between the tool horn 6 and the anvil 7. Then, the tool horn 6 and the anvil 7 are pressed by the pressing machine and then, the piezoelectric vibrator 5 is provided with a voltage to generate ultrasonic vibration. The generated ultrasonic vibration is transmitted to one piece 2 through the tool horn 6. At that time, since the tool horn 6 and the anvil 7 are pressed by the pressing machine in a direction in which the tool horn 6 and the anvil 7 approach each other, the tool horn 6 and the one piece 2 vibrate integrally by the ultrasonic vibration. Then, the pair of the pieces 2 bonded together shifts relatively to each other due to the ultrasonic vibration, so that the adhesive layer 4 is heated, that is, the adhesive layer 4 is broken or, alternatively, mechanical strength of the adhesive layer 4 is decreased.

Thus, the ultrasonic vibration affects the adhesive layer 4 through the tool horn 6 and the one piece 2. Thereafter, the vibration of the piezoelectric vibrator 5 by the ultrasonic vibration applying device 3 and the pressing by the pressing machine are halted, then the adhesive-bonded body 1 is taken out from between the tool horn 6 and the anvil 7.

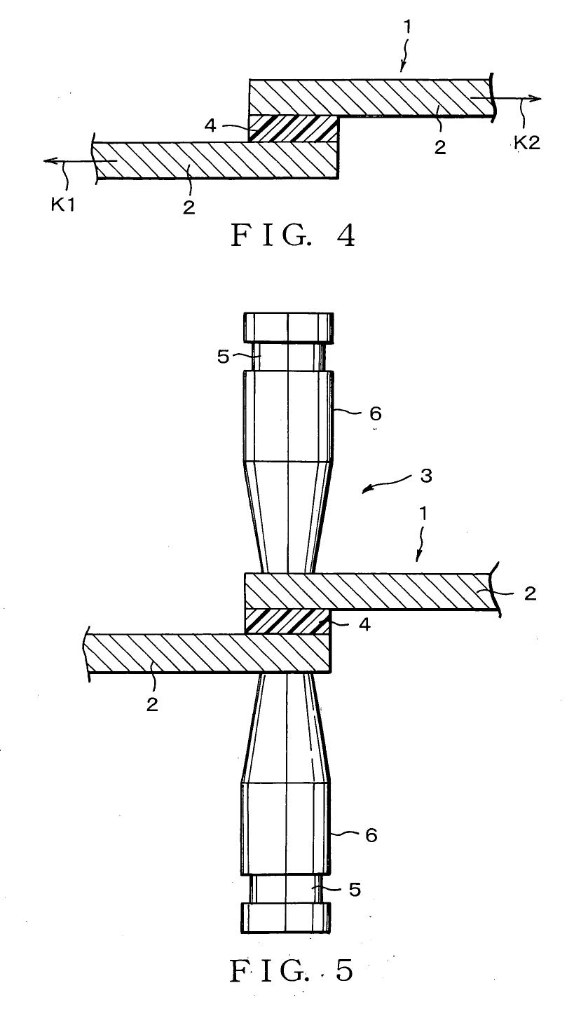

When the adhesive layer 4 having thus decreased mechanical strength still bonds the pair of the bonded pieces 2 to each other, the pair of the bonded pieces 2 is shifted in a direction in which the bonded pieces 2 are parted away from each other, that is, along the arrows K1 and K2 shown in FIG. 4. Directions of the arrows K1 and K2 are parallel to the length direction of the piece 2. Then, the adhesive layer 4 is broken, so that the bonded pieces 2 are separated from each other. Thus, in the method of separating the adhesive-bonded body 1 according to the present invention, the ultrasonic vibration is affected to the adhesive layer 4 through the one piece 2 of the pair of the pieces 2 bonded together with the adhesive layer 4, so that the piece 2 and the adhesive layer 4 can be easily separated from each other, that is, the pair of the bonded pieces 2 can be easily separated from each other.

According to the preferred embodiment, the tool horn 6 comes in contact with the piece 2 of the adhesive-bonded body 1 and the tool horn 6 is subjected to the ultrasonic vibration. Therefore, the ultrasonic vibration can be effectively transmitted to the adhesive layer 4 through the tool horn 6 and the one piece 2. The ultrasonic vibration is transmitted to the adhesive layer 4, causing the adhesive layer 4 to be broken or, alternatively, the mechanical strength of the adhesive layer 4 to be decreased, thereby enabling the separation of the bonded pieces 2.

Therefore, the bonded piece 2 can be prevented from being seriously damaged and the pair of the pieces 2 bonded together can be separated from each other effectively in a short period of time. Differently from the breaking of the adhesive layer 4 by normal heating, energy can be intensively applied to the adhesive layer 4 instead of simultaneous heating of the pieces 2 bonded together, therefore the piece 2 can be prevented from being damaged and freedom of selecting material of the piece 2 is large.

Since the adhesive described above for constructing the adhesive layer 4 used in the present invention can be utilized, the application range of the present invention is practically very wide.

The ultrasonic vibration is made affective through the tool horn 6. Therefore, the ultrasonic vibration is securely applied to the adhesive layer 4 situated between the pair of the bonded pieces 2. Therefore, the pair of the pieces 2 bonded together can be securely separated from each other.

When the tool horn 6 is subjected to the ultrasonic vibration along the arrow Z, the tool horn 6 vibrates along a direction in which the pair of the bonded pieces 2 overlaps with each other. Therefore, the mechanical strength of the adhesive layer 4 can be securely decreased. Therefore, the pair of the pieces 2 bonded together can be securely separated from each other.

When the reactive adhesive is used as the adhesive for constructing the adhesive layer 4 in the adhesive-bonded body 1, the separation of the pair of the bonded pieces 2 is possible. Further, in such a case, since the reactive adhesive has strength and heat resistance higher than those of an adhesive consisting of thermoplastic resin, the application range of the method according to the present invention is wide. That is, the separation of the pair of the bonded pieces 2 of the adhesive-bonded body 1 having wide variety can be possible.

That is, the method according to the present invention can be applied to a reactive adhesive that has excellent adhesive force and excellent heat-resisting adhesion property. The adhesive can be separated therefrom in a short period of time. Since the adhesive layer and the bonded piece can be separated from each other in a short period of time without occurrence of dust or noise, therefore it greatly contributes to development of recycling business or promotion of recycling.

In the preferred embodiment described above, the ultrasonic vibration applying device 3 puts the adhesive-bonded body 1 between the tool horn 6 and the anvil 7 and applies the ultrasonic vibration to the adhesive layer 4 of the adhesive-bonded body 1. However, in the present invention, as shown in FIG. 5, the ultrasonic vibration applying device 3 may have a pair of tool horns 6 without using an anvil 7. That is, the ultrasonic vibration applying device 3 may put the adhesive-bonded body 1 between the pair of tool horns 6 and apply the ultrasonic vibration to the adhesive layer 4 of the adhesive-bonded body 1. In this case, the tool horns 6 are attached to the respective piezoelectric vibrators 5 as shown in FIG. 5. Each tool horn 6 vibrates ultrasonically along the arrow Z or X due to the ultrasonic vibration generated when a voltage is applied to each piezoelectric vibrator 5.

When the ultrasonic vibration applying device 3 shown in FIG. 5 is used, the adhesive-bonded body 1 is put between the tool horns 6. Then, a voltage is applied to each piezoelectric vibrator 5 so as to vibrate the piezoelectric vibrator 5 ultrasonically. Both tool horns 6 ultrasonically vibrate and the tool horns 6 ultrasonically vibrate together with the respective pieces 2. Then, due to the ultrasonic vibration, the pair of the bonded pieces 2 shifts relatively to each other, so that the adhesive layer 4 is heated, that is, the adhesive layer 4 is broken or, alternatively, mechanical strength of the adhesive layer 4 is decreased.

When the adhesive layer 4 having thus decreased mechanical strength still bonds the pair of the bonded pieces 2 to each other, the pair of the bonded pieces 2 is shifted in a direction in which the bonded pieces 2 are parted away from each other, that is, along the arrows K1 and K2 shown in FIG. 4, so that the pair of the bonded pieces 2 is separated from each other. Directions of the arrows K1 and K2 are parallel to the length direction of the piece 2. Thus, in the present invention, the pair of the tool horns 6 may come in contact with the respective pieces 2, so that the ultrasonic vibration is applied to the adhesive layer 4 through both pieces 2 bonded together. After all, in the present invention, the ultrasonic vibration is applied to the adhesive layer 4 through at least one piece 2 of the pair of the pieces 2 bonded together, so that the pair of the pieces 2 bonded together is separated from each other.

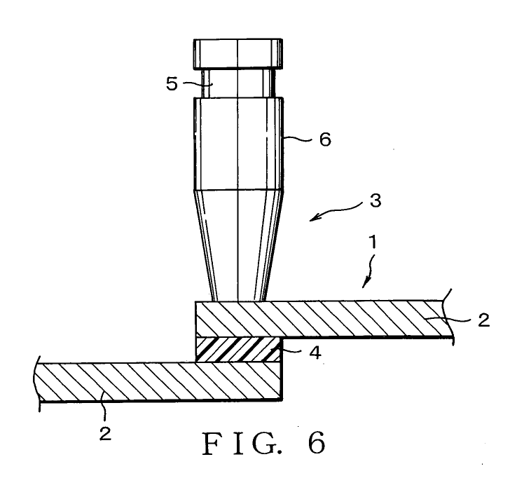

As shown in FIG. 6, in the present invention, the ultrasonic vibration applying device 3 may be provided with only one tool horn 6. That is, the ultrasonic vibration applying device 3 may apply the ultrasonic vibration to the adhesive layer 4 of the adhesive-bonded body 1 by using only one tool horn 6. The tool horn 6 of the ultrasonic vibration applying device 3 shown in FIG. 6 is attached to the piezoelectric vibrator 5. The tool horn 6 vibrates ultrasonically along the arrow Z or X due to the ultrasonic vibration generated when a voltage is applied to the piezoelectric vibrator 5.

The inventors confirmed the effects of the present invention as follows. First, as shown in Table 1, EXAMPLES 1, 2 and 3 in which ultrasonic vibration was applied to the adhesive layer 4 according to a method of the present invention were compared with COMPARATIVE EXAMPLES 1, 2, 3 and 4 in which a method different from that of the present invention was used for separating bonded pieces 2.

TABLE 1

| | | | | COMPARA- | COMPARA- | COMPARA- | COMPARA- |
|---|---|---|---|---|---|---|---|
| | | | | TIVE | TIVE | TIVE | TIVE |
| | EXAMPLE 1 | EXAMPLE 2 | EXAMPLE 3 | EXAMPLE 1 | EXAMPLE 2 | EXAMPLE 3 | EXAMPLE 4 |
| ADHESIVE | MODIFIED | MODIFIED | MODIFIED | MODIFIED | MODIFIED | MODIFIED | MODIFIED |
| | SILICONE- | SILICONE- | SILICONE- | SILICONE- | SILICONE- | SILICONE- | SILICONE- |
| | BASED | BASED | BASED | BASED | BASED | BASED | BASED |
| | ADHESIVE | ADHESIVE | ADHESIVE | ADHESIVE | ADHESIVE | ADHESIVE | ADHESIVE |
| SEPARATING | ULTRASONIC | ULTRASONIC | ULTRASONIC | HEATING | HEATING + | CUTTER | CUTTER |
| MEANS | WAVE | WAVE | WAVE | | FOAMED | | |
| | | | | | PARTICLE | | |
| | | | | | MIXING | | |
| PIECE TO BE | POLY- | COPPER | POLY- | POLY- | POLY- | POLY- | POLY- |
| BONDED | CARBONATE | | CARBONATE | CARBONATE | CARBONATE | CARBONATE | CARBONATE |
| | 50 mm × | 50 mm × | 50 mm × | 50 mm × | 50 mm × | 50 mm × | 50 mm × |
| | 10 mm × | 10 mm × | 50 mm × | 10 mm × | 10 mm × | 10 mm × | 50 mm × |
| | 2 mm | 2 mm | 2 mm | 2 mm | 2 mm | 2 mm | 2 mm |
| | 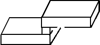 | 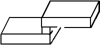 | 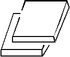 | 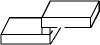 | 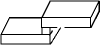 | 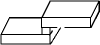 | 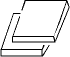 |
| STRENGTH | 140 N | 145 N | 140 N | 140 N | 120 N | 140 N | 150 N |
| BEFORE | | | | | | | |
| PROCESSING | | | | | | | |
| (at 20° C.) | | | | | | | |
| STRENGTH | 20 N | 50 N | 20 N | 120 N | 5 N | 0 N | 150 N |
| AFTER | | | | | | | |
| PROCESSING | | | | | | | |
| PROCESSING | 1 SEC. | 2 SEC. | 1 SEC. | 300° C. × | 150 × | 3 SEC. | CUTTER |
| TIME OR | | | | 1 min | 1 hr | | BLADE NOT |
| CUTTING TIME | | | | | | | REACHED TO |
| | | | | | | | ADHESIVE |
| | | | | | | | LAYER |
| DAMAGE OF | NO DAMAGE | NO DAMAGE | NO DAMAGE | PARTIALLY | NO DAMAGE | DAMAGE | APPLICATION |
| BONDED PIECE | | | | MELTED | | | IMPOSSIBLE |
| ADAPTABILITY | GOOD | GOOD | GOOD | NOT GOOD | NOT GOOD | NOT GOOD | NOT GOOD |
| TO SEPARATING | | | | | DUE TO | | |
| OPERATION OF | | | | | LONG | | |
| BONDED PIESES | | | | | OPERATING | | |
| | | | | | TIME | | |

As for EXAMPLE 1 in Table 1, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other along the arrows K1 and K2 shown in FIG. 4. At that time, the force (i.e. shearing force of the adhesive layer 4) was measured.

As for EXAMPLE 2 in Table 1, a modified silicone-based adhesive (brand name; Sekisui Bond for House #72-A, manufactured by Sekisui Chemical Co., LTD.) was used as the adhesive for constructing the adhesive layer 4. A copper (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was lateral vibration (arrow X), and the voltage-applying time to the piezoelectric vibrator 5 was 2 seconds. Thereafter, the pieces 2 bonded together of the adhesive-bonded body 1 were separated from each other along the arrows K1 and K2 shown in FIG. 4. At that time, the force (i.e. shearing force of the adhesive layer 4) was measured.

As for EXAMPLE 3 in Table 1, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×50×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other along the arrows K1 and K2 shown in FIG. 4. At that time, the force (i.e. shearing force of the adhesive layer 4) was measured.

As for COMPARATIVE EXAMPLE 1 in Table 1, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, the adhesive-bonded body 1 was heated at 300° C. in an electric furnace for 1 minute. Thereafter, the pieces 2 bonded together of the adhesive-bonded body 1 were separated from each other along the arrows K1 and K2 shown in FIG. 4. At hat time, the force (i.e. shearing force of the adhesive layer 4) was measured.

As for COMPARATIVE EXAMPLE 2 in Table 1, an adhesive obtained by mixing thermally expansive hollow particles of an amount of 20 weight part into a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, the adhesive-bonded body 1 was heated at 150° C. in an oven for 60 minutes. Thereafter, the pieces 2 bonded together of the adhesive-bonded body 1 were separated from each other along the arrows K1 and K2 shown in FIG. 4. At that time, the force (i.e. shearing force of the adhesive layer 4) was measured.

As for COMPARATIVE EXAMPLE 3 in Table 1, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×50×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, a cutter blade being vibrated ultrasonically by a piezoelectric vibrator was directly applied to the adhesive layer 4 so as to cut the adhesive layer 4, and the pair of the pieces 2 bonded together of the adhesive-bonded body 1 was separated from each other.

As for COMPARATIVE EXAMPLE 4 in Table 1, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×50×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, a cutter blade being vibrated ultrasonically by a piezoelectric vibrator was attempted to be directly applied to the adhesive layer 4 so as to cut the adhesive layer 4, however, the cutter blade could not reach the adhesive layer 4 due to the obstruction of the piece 2, therefore the pair of the pieces 2 bonded together of the adhesive-bonded body 1 could not be separated from each other.

As for the EXAMPLES 1-3 and the COMPARATIVE EXAMPLES 1-4, the force (i.e. shearing force of the adhesive layer 4) was measured when the pieces 2 bonded together of the adhesive-bonded body 1 were separated from each other along the arrows K1 and K2 shown in FIG. 4 on a condition that the environmental temperature was 20° C. and the shifting speed (pulling speed) of the pieces 2 along the arrows K1 and K2 was 50 mm/min.

Further, for comparison, corresponding to each of the EXAMPLES 1-3 and the COMPARATIVE EXAMPLES 1-4, another adhesive-bonded body was additionally prepared in the same manner as described above and each additionally prepared adhesive-bonded body was not subjected to the application of ultrasonic vibration, heating or cutting with the cutter blade. Then, the force (i.e. shearing force of the adhesive layer) measured when the pieces bonded together of each additionally prepared adhesive-bonded body were separated from each other along the arrows K1 and K2 shown in FIG. 4 was obtained on the same condition as described above.

Table 1 reveals that as for each of the EXAMPLES 1-3 and COMPARATIVE EXAMPLES 1-3, the measured shearing force for adhesive-bonded body 1, which was subjected to the application of ultrasonic vibration, heating or cutting with the cutter blade, was markedly deteriorated compared to the corresponding measured shearing force for adhesive-bonded body 1, which was not subjected to the application of ultrasonic vibration, heating or cutting with the cutter blade. That is, it was confirmed that as for each of the EXAMPLES 1-3 and COMPARATIVE EXAMPLES 1-3, the pieces 2 bonded together of the adhesive-bonded body 1 could be securely easily separated from each other. Thus, it was confirmed that as for the EXAMPLES 1-3, since the ultrasonic vibration could be effectively transmitted to the adhesive layer 4 through the piece 2, therefore the mechanical strength of the adhesive layer 4 could be deteriorated.

However, it was also confirmed that as for the COMPARATIVE EXAMPLES 1-3, the piece 2 was partially melted (COMPARATIVE EXAMPLE 1) or the piece 2 was damaged (i.e. flaw formation; COMPARATIVE EXAMPLE 3), whereas as for the EXAMPLES 1-3, the piece 2 was not damaged. That is, it was confirmed that the COMPARATIVE EXAMPLES 1 and 3 were not appropriate to separate the pieces 2 bonded together from the viewpoint of recycling.

In the COMPARATIVE EXAMPLE 4, the adhesive layer 4 could not be cut with the cutter blade. Therefore, it was confirmed that the COMPARATIVE EXAMPLE 4 was not appropriate to separate the pieces 2 bonded together. Further, in the COMPARATIVE EXAMPLE 2, the adhesive-bonded body 1 was left in the oven for 60 minutes, whereas in the EXAMPLES 1-3, the voltage-applying time to the piezoelectric vibrator 5 was 1 or 2 seconds. That is, it was confirmed that the COMPARATIVE EXAMPLE 2 was not appropriate to separate the pieces 2 bonded together because the COMPARATIVE EXAMPLE 2 required a long period of time for separating the pieces 2 bonded together compared to the period of time required in the EXAMPLES 1-3.

Thus, Table 1 reveals that in each of the EXAMPLES 1-3, the piece 2 was prevented from being seriously damaged and the pieces 2 bonded together of the adhesive-bonded body 1 could be separated from each other effectively in a short period of time.

Further, the inventors applied ultrasonic vibration to the adhesive-bonded body 1 consisting of pieces 2 made of various material according to a method of the present invention and measured a difference in the effects of the ultrasonic vibration of longitudinal vibration (arrow Z) and the ultrasonic vibration of lateral vibration (arrow X). The results are shown in Tables 2 and 3.

TABLE 2

| ADHESIVE- | ADHESIVE- | ADHESIVE- | ADHESIVE- | ADHESIVE- | ADHESIVE- | ADHESIVE- |
|---|---|---|---|---|---|---|
| BONDED | BONDED | BONDED | BONDED | BONDED | BONDED | BONDED |
| BODY | BODY A | BODY B | BODY C | BODY D | BODY E | BODY F |
| ADHESIVE | MODIFIED | MODIFIED | MODIFIED | MODIFIED | MODIFIED | MODIFIED |
| | SILICONE- | SILICONE- | SILICONE- | SILICONE- | SILICONE- | SILICONE- |
| | BASED | BASED | BASED | BASED | BASED | BASED |
| | ADHESIVE | ADHESIVE + | ADHESIVE | ADHESIVE | ADHESIVE + | ADHESIVE |
| | | FOAMED PARTICLE | | | FOAMED PARTICLE | |
| FREQUENCY | 40 kHz | 40 kHz | 40 kHz | 40 kHz | 40 kHz | 40 kHz |
| VIBRATION | 1 SEC. | 1 SEC. | 1 SEC. | 2 SEC. | 2 SEC. | 2 SEC. |
| TIME | | | | | | |
| VIBRATING | LONGITU- | LONGITU- | LONGITU- | LATERAL | LATERAL | LATERAL |
| DIRECTION | DINAL | DINAL | DINAL | | | |
| PIECE TO BE | POLY- | POLYCARBONATE | COPPER | POLYCARBONATE | POLYCARBONATE | COPPER |
| BONDED | CARBONATE | | | | | |
| | 50 mm × | 50 mm × | 50 mm × | 50 mm × | 50 mm × | 50 mm × |
| | 10 mm × | 10 mm × | 10 mm × | 10 mm × | 10 mm × | 10 mm × |
| | 2 mm | 2 mm | 2 mm | 2 mm | 2 mm | 2 mm |
| | 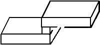 | 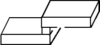 | 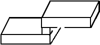 | 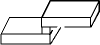 | 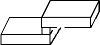 | 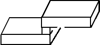 |
| STRENGTH BEFORE | 125 N | 149 N | 143 N | 125 N | 149 N | 143 N |
| PROCESSING | | | | | | |
| (at 20° C.) | | | | | | |
| STRENGTH AFTER | 27 N | 1 N | 102 N | 68 N | 5 N | 16 N |
| PROCESSING | | | | | | |
| STRENGTH | | | | | | |
| AFTER | | | | | | |
| PROCESSING | | | | | | |
| ———100(%) | 21.6% | 0.7% | 71.3% | 54.4% | 3.3% | 11.1% |
| STRENGTH | | | | | | |
| BEFORE | | | | | | |
| PROCESSING | | | | | | |

TABLE 3

| | ADHESIVE- | ADHESIVE- | | | |
|---|---|---|---|---|---|
| ADHESIVE-BONDED | BONDED | BONDED | ADHESIVE-BONDED | ADHESIVE-BONDED | ADHESIVE-BONDED |
| BODY | BODY G | BODY H | BODY I | BODY J | BODY K |
| ADHESIVE | MOISTURE- | SILICONE- | RUBBER-BASED | MODIFIED | MODIFIED |
| | SETTING | BASED | HOT MELT | SILICONE-BASED | SILICONE-BASED |
| | URETHAN-BASED | | | | |
| FREQUENCY | 40 kHz | 40 kHz | 40 kHz | 40 kHz | 40 kHz |
| VIBRATION TIME | 1 SEC. | 2.5 SEC. | 1 SEC. | 1 SEC. | 2 SEC. |
| VIBRATING DIRECTION | LONGITUDINAL | LONGITUDINAL | LONGITUDINAL | LONGITUDINAL | LONGITUDINAL |
| PIECE TO BE | POLY- | POLY- | POLYCARBONATE | SLATE × TILE | LAUAN MATERIAL |
| BONDED | CARBONATE | CARBONATE | | | |
| | 50 mm × 10 mm × | 50 mm × 10 mm × | 50 mm × 10 mm × | 50 mm × 10 mm × | 50 mm × 10 mm × |
| | 2 mm | 2 mm | 2 mm | 2 mm | 2 mm |
| | 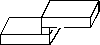 | 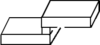 | 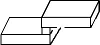 | 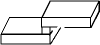 | 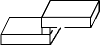 |
| STRENGTH BEFORE | 384 N | 114 N | 85 N | 182 N | 182 N |
| PROCESSING | | | | | |
| (at 20° C.) | | | | | |
| STRENGTH AFTER | 61 N | 34 N | 11 N | 21 N | 81 N |
| PROCESSING | | | | | |
| STRENGTH | | | | | |
| AFTER | | | | | |
| PROCESSING | | | | | |
| ———100(%) | 15.9% | 29.8% | 12.9% | 11.5% | 44.5% |
| STRENGTH | | | | | |
| BEFORE | | | | | |
| PROCESSING | | | | | |

As for an adhesive-bonded body A in Table 2, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 2 mm and the adhesion area was 1 cm², and a pair of the pieces 2 thus bonded together. was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body B in Table 2, an adhesive obtained by mixing thermally expansive hollow particles of an amount of 20 weight part into a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body C in Table 2, a modified silicone-based adhesive (brand name; Sekisui Bond for House #72-A, manufactured by Sekisui Chemical Co., LTD.) was used as the adhesive for constructing the adhesive layer 4. A copper (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body D in Table 2, a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 2 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was lateral vibration (arrow X), and the voltage-applying time to the piezoelectric vibrator 5 was 2 seconds. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body E in Table 2, an adhesive obtained by mixing thermally expansive hollow particles of an amount of 20 weight part into a modified silicone-based adhesive (brand name; Sekisui Bond for House #72-A, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was lateral vibration (arrow X), and the voltage-applying time to the piezoelectric vibrator 5 was 2 seconds. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body F in Table 2, a modified silicone-based adhesive (brand name; Sekisui Bond for House #72-A, manufactured by Sekisui Chemical Co., LTD.) was used as the adhesive for constructing the adhesive layer 4. A copper (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was lateral vibration (arrow X), and the voltage-applying time to the piezoelectric vibrator 5 was 2 seconds. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body G in Table 3, a moisture-setting Urethan-based adhesive (brand name; S-dine 9615W, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body H in Table 3, a silicone-based adhesive (brand name; Sekisui Silicone Sealant, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 2.5 seconds. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body I in Table 3, a rubber-based hot melt adhesive (brand name; S-dine 9189G, manufactured by Sekisui Chemical Co., LTD.) was used as the adhesive for constructing the adhesive layer 4. A polycarbonate (size; 50×10×2 mm) was used as the piece 2, the adhesion was carried out on a condition that the thickness of the adhesive layer 4 was 1 mm and the adhesion area was 1 cm^{2, and a pair of the pieces 2 thus bonded together was kept at} 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body J in Table 3, a modified silicone-based adhesive (brand name; Sekisui Bond for House #72-A, manufactured by Sekisui Chemical Co., LTD.) was used as the adhesive for constructing the adhesive layer 4. A slate (size; 50×10×2 mm) and a tile (size; 50×10×2 mm) were used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 1 second. Thereafter, the pieces 2 bonded together of the adhesive-bonded body 1 were separated from each other and at that time the shearing force of the adhesive layer 4 of the adhesive-bonded body 1 was measured in the same manner as that of Table 1.

As for an adhesive-bonded body K in Table 3, a modified silicone-based adhesive (brand name; Sekisui Bond for House #72-A, manufactured by Sekisui Chemical Co., LTD.) was used as the adhesive for constructing the adhesive layer 4. A lauan material (size; 50×10×2 mm) was used as the piece 2, the adhesion was carried out on a condition that the thickness of the adhesive layer 4 was 1 mm and the adhesion area was 1 cm², and a pair of the pieces 2 thus bonded together was kept at 20° C. for one week. Thereafter, ultrasonic vibration was applied by using the ultrasonic vibration applying device 3 shown in FIG. 3 on a condition that the frequency was 40 kHz, the vibration was longitudinal vibration (arrow Z), and the voltage-applying time to the piezoelectric vibrator 5 was 2 seconds. Thereafter, the pieces 2 bonded together of the adhesive-bonded body 1 were separated from each other and at that time the shearing force of the adhesive layer 4 of the adhesive-bonded body 1 was measured in the same manner as that of Table 1.

Further, for comparison, corresponding to each of the adhesive-bonded bodies A-K, another adhesive-bonded body was additionally prepared in the same manner as described above and each additionally prepared adhesive-bonded body was not subjected to the application of ultrasonic vibration. Then, the force (i.e. shearing force of the adhesive layer) measured when the pieces bonded together of each additionally prepared adhesive-bonded body were separated from each other along the arrows K1 and K2 shown in FIG. 4 was obtained on the same condition as described above.

Tables 2 and 3 reveal that for both of the longitudinal vibration (arrow Z) and the lateral vibration (arrow X), the shearing force of the adhesive layer 4 of each of the samples subjected to the ultrasonic vibration was further deteriorated compared to that of the corresponding samples not subjected to the ultrasonic vibration. Moreover, for both of the longitudinal vibration (arrow Z) and the lateral vibration (arrow X), the voltage-applying time to the piezoelectric vibrator 5 was short so that the pieces 2 were not damaged. Therefore, for both of the longitudinal vibration (arrow Z) and the lateral vibration (arrow X), a pair of the pieces 2 bonded together of the adhesive-bonded body 1 could be efficiently separated from each other in a short period of time without being seriously damaged. Thus, it was confirmed that in the present invention, the ultrasonic vibration could be transmitted to the adhesive layer 4 through the piece 2 made of resin, metal, stone or wood material and that the mechanical strength of the adhesive layer 4 could be securely decreased in the present invention.

Further, Table 2 reveals that a ratio of the strength (i.e. shearing force) of the adhesive layer 4 after processing of ultrasonic longitudinal vibration (arrow Z) to that before the processing for the adhesive-bonded body C was 71.3%, whereas ratios of the strength (i.e. shearing force) of the adhesive layer 4 after processing of ultrasonic longitudinal vibration (arrow Z) to that before the processing for the adhesive-bonded bodies A and B were 21.6% and 0.7%, respectively. Therefore, it was confirmed that the ultrasonic longitudinal vibration (arrow Z) was effective for decreasing the mechanical strength of the adhesive layer 4, which bonds the pieces 2 made of synthetic resin together. That is, it was confirmed that the ultrasonic longitudinal vibration (arrow Z) was effective for separating the bonded pieces 2 made of synthetic resin.

Further, Table 2 reveals that a ratio of the strength (i.e. shearing force) of the adhesive layer 4 after processing of ultrasonic lateral vibration (arrow X) to that before the processing for the adhesive-bonded body F was 11.1%, whereas a ratio of the strength (i.e. shearing force) of the adhesive layer 4 after processing of ultrasonic lateral vibration (arrow X) to that before the processing for the adhesive-bonded body D was 54.4%. Therefore, it was confirmed that the ultrasonic lateral vibration (arrow X) was effective for decreasing the mechanical strength of the adhesive layer 4, which bonds the pieces 2 made of metal together. That is, it was confirmed that the ultrasonic lateral vibration (arrow X) was effective for separating the bonded pieces 2 made of metal.

Further, Table 2 reveals that a ratio of the strength (i.e. shearing force) of the adhesive layer 4 after processing of ultrasonic longitudinal vibration (arrow Z) to that before the processing for the adhesive-bonded body B was 0.7%, whereas a ratio of the strength (i.e. shearing force) of the adhesive layer 4 after processing of ultrasonic longitudinal vibration (arrow Z) to that before the processing for the adhesive-bonded body A was 21.6%. Furthermore, Table 2 reveals that a ratio of the strength (i.e. shearing force) of the adhesive layer 4 after processing of ultrasonic lateral vibration (arrow X) to that before the processing for the adhesive-bonded body E was 3.3%, whereas a ratio of the strength (i.e. shearing force) of the adhesive layer 4 after processing of ultrasonic lateral vibration (arrow X) to that before the processing for the adhesive-bonded body D was 54.4%. That is, it was confirmed that the mixing of the foamed particles into the adhesive was effective for decreasing the mechanical strength of the adhesive layer 4.

Besides the separation of the pieces 2 bonded together with the adhesive, the method of the present invention can also be applied to sealing, molding, potting, non-slip use, gasket or laminate and formed body consisting of materials of different types, which requires separation upon disposal.

In the preferred embodiment described above, after applying the ultrasonic vibration, the pair of the bonded pieces 2 is shifted along the arrows K1 and K2 shown in FIG. 4, that is, in a direction in which the bonded pieces 2 are parted away from each other, so as to separate the bonded pieces 2. However, instead, in the present invention, after applying the ultrasonic vibration, the pair of the bonded pieces 2 may be shifted in a direction in which the bonded pieces 2 are parted away from each other along the direction (arrow Z), in which the pair of pieces 2 overlaps each other, so as to separate the bonded pieces 2. In other words, in the present invention, after applying the ultrasonic vibration, the pair of the bonded pieces 2 may be shifted in any direction so as to separate the bonded pieces 2 provided that the bonded pieces 2 are parted away from each other when the bonded pieces 2 is shifted in said direction.

Furthermore, in the present invention, after applying the ultrasonic vibration, an operator may shift the bonded pieces 2 in a direction in which the bonded pieces 2 are parted away from each other with operator's hands so as to separate the bonded pieces 2 or, alternatively, the bonded pieces 2 may be shifted in a direction in which the bonded pieces 2 are parted away from each other by using a tool or machine so as to separate the bonded pieces 2.

The aforementioned preferred embodiments are described to aid in understanding the present invention and variations may be made by one skilled in the art without departing from the spirit and scope of the present invention.

1. A method of separating an adhesive-bonded body including a pair of pieces bonded together by an adhesive layer into the respective separated pieces comprising the step of:
affecting the adhesive layer with ultrasonic vibration through at least one piece of the pair of the pieces bonded together, thereby separating the pair of the pieces bonded together into the respective separated pieces.

2. The method of separating an adhesive-bonded body according to claim 1, wherein the ultrasonic vibration is generated by applying a voltage to a piezoelectric vibrator so as to vibrate the piezoelectric vibrator and the ultrasonic vibration is transmitted to the adhesive layer through a tool horn which comes in contact with at least one piece of the pair of the pieces bonded together.

3. The method of separating an adhesive-bonded body according to claim 2, wherein the ultrasonic vibration is a vibration along a direction in which the pair of the pieces bonded together overlaps each other.

4. The method of separating an adhesive-bonded body according to claim 2, wherein the ultrasonic vibration is a vibration along a direction crossing at right angles a direction in which the pair of the pieces bonded together overlaps each other.

5. The method of separating an adhesive-bonded body as claimed in claim 1, wherein the adhesive layer consists of a reactive adhesive.
